(19) United States
(12) Patent Application Publication
(10) Pub. No.: US 2003/0030813 A1
(43) Pub. Date: Feb. 13, 2003

(54) Instrument to measure the amount of condensation during gaseous sterilisation process

(76) Inventor: Anthony Martin, Hampshire (GB)

Correspondence Address: WORKMAN NYDEGGER & SEELEY, 1000 EAGLE GATE TOWER, 60 EAST SOUTH TEMPLE, SALT LAKE CITY, UT, 84111, US

(21) Appl. No.: 10/239,111

(22) PCT Filed: Mar. 20, 2001
(86) PCT No.: PCT/GB01/01224

(51) Int. Cl. G01N 21/55

(52) U.S. Cl. 356/445

(57) ABSTRACT

The disclosure relates to a condensation monitor for measuring condensation on one side of a window (10) from the other side thereof, the window being located in an enclosure (23) mounted on a chamber wall with a part opening with the interior of the chamber. The monitor comprises a pair of optical prisms (14, 20) positioned on the other side of the window at spaced apart locations to provide transmission of an obliquely angled beam of light into the window and transmission of an obliquely angled beam of light out of the window. A light source (12, 13) adjacent one of the devices provides a parallel beam of light to be transmitted by said device into the window to travel along the window by reflection from side to side to the other device from where the light beam emerges and a light sensor (22) measures the amount of light emerging from the window. The amount of light transmitted along the portion between the optical devices depends on the amount of condensation on said one side of the window, condensation facilites losses of the light through said one side by refraction reducing the amount of light transmitted. along the window to the light sensor.

The present invention relates to the measurement and control of the level of condensation inside a chamber that is being sterilised using a gaseous delivery method of the sterilant.

Most of the methods of gaseous surface sterilisation used in the Pharmaceutical Industry are more effective when fine layers of condensation are produced. M. A. Marcos et al (see Reference I identified in detail later) has stated that in processes where 30% hydrogen peroxide at 100° C. is injected into a chamber at 30° C. then “condensation is a phenomenon that cannot be avoided, according to the laws of physics”. Other authorities have for some time believed that gaseous surface sterilisation using hydrogen peroxide is a dry gas process, but work by Watling et al (see Reference II identified in detail later) has shown evidence of condensation as the main factor causing sterilisation.

Since it is now believed that condensation is the single most important factor in achieving surface sterilisation when using gases, such as hydrogen peroxide, It is important that the amount of the condensation is measured and controlled. It would be a simple matter to ‘inject’ sufficient gas to cause gross condensation and hence achieve the required level of biological kill. There are two major disadvantages to such a technique they are, firstly that an excessive amount of chemical would be required with the associated cost implications, and secondly, and perhaps of greater importance, such gross condensation will increase the down time of the chamber that is being sterilised. The time taken to produce the gross condensation will obviously be longer than would be required to produce the optimum level, but as more sterilant must be removed at the end of the cycle then the aeration time would also be increased. The removal of the sterilant from a chamber is frequently the longest part of a sterilisation cycle, partly because aeration must continue to remove the gas concentration to very low levels, but also because of absorption of the sterilant into the surfaces. The longer the condensed sterilant is in contact with the surface the greater the degree of absorption and hence the greater the time taken for aeration.

The way in which droplets of moisture condense from a saturated vapour onto a surface are discussed and explained by M. A. Marcos et al. Droplets of dew are formed on a surface when a saturated vapour comes into contact with a surface at a lower temperature. Given a sufficient supply of the saturated vapour the droplets on the surface will generate a concentration gradient in the vapour around the droplet drawing in more vapour to increase the size of the droplet. This process will continue until the droplets grow to such a size that they touch and combine. The shape of the droplets will be defined by the wetting angle of the liquid on the surface. Where the wetting angle is large, such as with droplets of water forming on glass, the droplets remain almost spherical. If the wetting angle becomes zero because of some treatment of the surface then a thin film of dew would form over the whole surface.

With hydrogen peroxide and water vapour the droplets of dew which form on clean glass are initally very small and separated, and as the level of condensation increases so does the percentage of the surface area that is covered by droplets.

International Publication No. WO98112546 describes a technique for measuring the proportion of the surface area that is obscured by the formation of droplets. The technique taught in this patent is to shine a light onto a specially prepared surface and measure the change in the reflected light as the droplets are deposited on the surface.. Whilst the technique gives excellent results it has the disadvantage that the instrument needs to be placed inside the chamber to be sterilised, and it must be in intimate thermal contact with the chamber surface.

EP-A-0444520 discloses a sensor for detecting the degree of wetting of a transparent window and in particular detecting droplet-like precipitation. A beam guide member is coupled to the window with a beam transmitter and a beam receiver, is associated and the window has a reflection means for multiple reflection of the beams transmitted by the beam transmitter. The arrangement is intended to solve the technical problem of preventing the signal supplied by the beam receiver and which depends on the amount of precipitation, from being adversely affected by atmospheric humidity even with relatively large temperature differences. This is achieved in that the reflection means comprises a very thin layer of material which has a mirror-finish surface, and which is intimately connected to a surface of the beam guide member extending parallel to the window.

EP-A-0843174 discloses a method of determining dew point which involve s directing a gas under investigation on to a cooled section of an optically transparent body through which a luminous flux is allowed to pass and recording fluctuations in the intensity of the luminous flux. The flow-rate of the gas thus directed on to the cooled section is reduced down to zero while its molecular diffusion is preserved. To limit the flow rate of the gas impinging on the cooled section and reduce contamination of the optically transparent element. A dew point gauge is provided with a sampling tube.

U.S. Pat. No. 3,528,278 discloses apparatus and method for determining the presence of vapour in a gas. One of the uses of this invention is the determination of the dew point of the air of the atmosphere. A translucent body and a source of radiant energy are employed. Light energy enters the translucent body and engages a surface thereof at such an angle of incidence that it is normally substantially totally reflected internally. However, if the translucent body has condensed vapour or condensate thereupon, such as is formed by dew, some of the light energy which engages the surface is refracted therethrough and a lesser amount of the energy is reflected therefrom. Means are provided for sensing the flow of reflected energy.

GB-1-1484613 discloses a windscreen soiling sensor having a light source which transmits a light onto the windscreen outer surface through a prism and the windscreen, and a light meter which registers the light reflected at the outer surface through the windscreen and a further prism at an angle equal or greater than the critical angle when the windscreen is clean, and a signal generator responsive to a change in the output of the light meter, characterised in that the light source, the light meter and the prisms are mounted in a common housing the light beam reflected from the outer surface being selected by an optical system and a diaphragm and being focussed onto the light meter, the prisms being fastened by means of transparent adhesive to the windscreen and the adhesive as well as the prisms have the same or substantially the same reference index as the windscreen.

This invention provides a chamber having a window, and a condensation monitor for measuring condensation on one side of the window from the other side thereof, the monitor a pair of optical devices positioned on said other side of the window at spaced apart locations to provide transmission of an obliquely angled beam of light into the window and transmission of an obliquely angled beam of light out of the window, a light source adjacent one of the devices to provide a parallel beam of light to be transmitted by said device into the window to travel along the window by reflection from side to side to the other device from where the light beam emerges, and a light sensor to measure the amount of light emerging from the window, the amount of light transmitted along the portion between the optical devices being dependent on the amount of condensation on said one side of the . window, condensation facilitating transmission of the light beam through said one side by refraction to reduce the amount of light transmitted along the window to the light sensor, wherein an enclosure is mounted on a wall of the chamber, said window being formed as part of the enclosure and said one side of the window on which condensation may form being exposed to the chamber interior and the other side having said condensation monitor.

In one arrangement according to the invention the enclosure is located within the chamber with an aperture in the chamber wall communicating the interior of the enclosure with the atmosphere outside of the chamber, said one side of the window in the enclosure being outside of the enclosure and exposed to the interior of the chamber and the monitor being mounted on the other side of the window within the enclosure.

When the surfaces are dry, a light beam directed from outside of the chamber into the glass window at an oblique angle may be trapped by total internal reflection between the two surfaces of the window in the same way that light is trapped in an optical fibre. However should a droplet of dew form on the inside of the window then because of the change in refractive index light will be allowed to escape through the droplet. As more of the surface becomes covered with droplets of dew so more light will escape. An optical sensor placed at the end of the light path will see a diminution of light intensity as more and mote droplets of dew form on the internal surface of the glass.

In one arrangement according to the invention the enclosure is located within the chamber with an aperture in the chamber wall communicating the interior of the enclosure with the atmosphere outside of the chamber, said one side of the window in the enclosure being outside of the enclosure and exposed to the interior of the chamber and the monitor being mounted on the other side of the window within the enclosure.

In addition a fan means may be provided for causing an air flow over the condensation monitor within the enclosure.

More specifically, the enclosure may have an opening communicating with atmosphere outside the chamber and the fan means may be arranged to draw air flow from outside the enclosure through the enclosure and thence to atmosphere outside of the chamber.

In an alternative arrangement according to the invention the enclosure may be located on the outside of the chamber with an aperture in the wall of the chamber communicating the interior of the enclosure with the interior of the chamber, said one side of the window in the enclosure being on the inner side of the enclosure and in communication with the interior of the chamber through the aperture and the monitor being mounted on said other side of the window externally of the enclosure.

In the latter arrangement fan means may be provided for drawing an airflow from the chamber into the enclosure over said one side of the window and then back to the chamber to enable condensation in the air contained in the chamber to be monitored.

In any of the above arrangements the optical devices may comprise prisms mounted on said one side of the window to transmit light into and receive light from the window respectively.

More specifically the prisms may be adhered by light transmitting contact pads to said one side of the window.

In any of the above arrangements the light source may have a lens for producing a parallel beam of light from the source.

Also in any of the above arrangements the light sensor may have a lens for focussing the parallel beam of light from the window to a point on the light sensor.

The following is a description of some specific embodiments of the invention, reference being made to the accompanying drawings, in which:

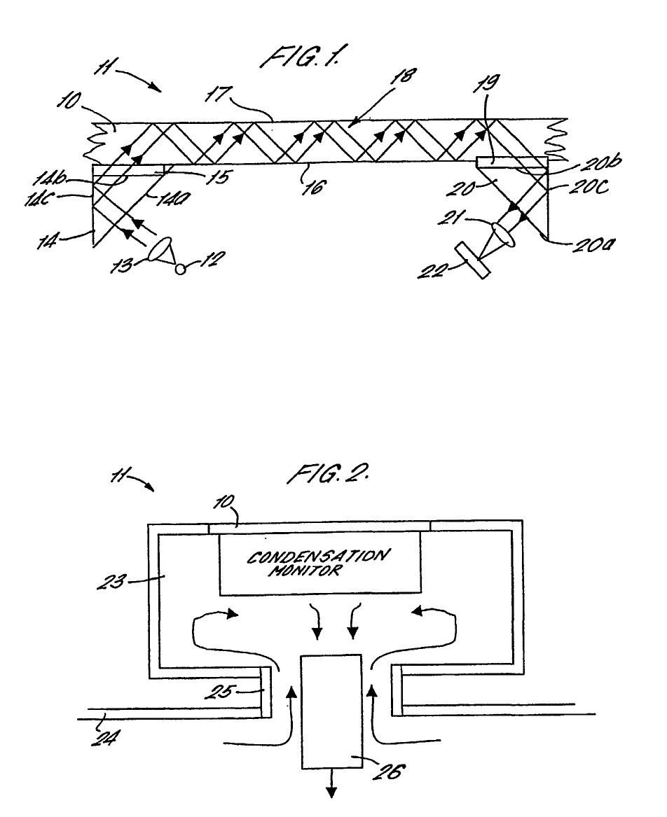

FIG. 1 is a detailed view of condensation measure monitor;

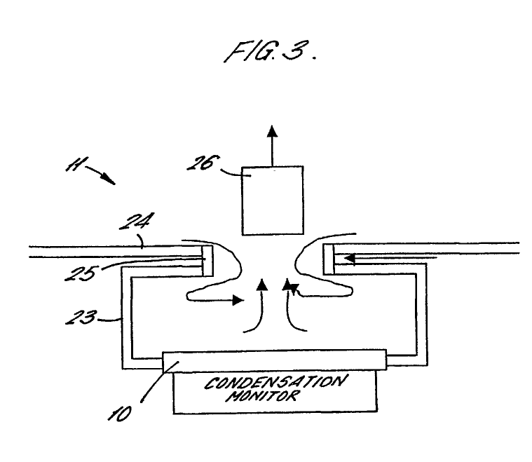

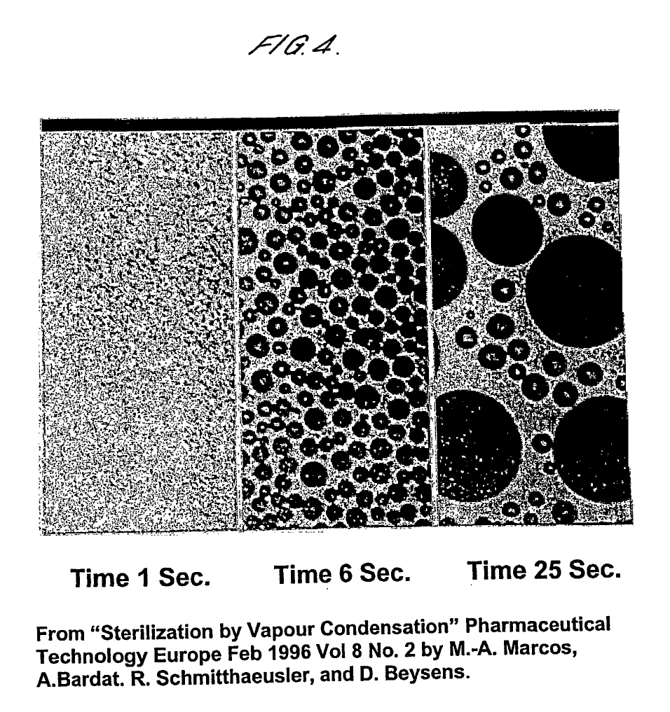

FIGS. 2 and 3 illustrate different applications of the monitor; and

FIG. 4 illustrates to an enlarged scale, the build up of moisture in the droplets on a surface.

The basic instrument is best understood by reference to FIG. 1, in which 10 is a glass window in the wall of the chamber indicated at 11 to be sterilised. A light source 12 passes light through a lens 13, which is selected and positioned so that it produces a parallel beam of light, which is projected into a right angled prism 14 mounted on the window with the hypotenuse 14a of the prism extending obliquely to the window a second side 14b lying parallel to the window and the strict side 14c extending at right angles to the window. Light from the lens is incident normal to the hypotenuse and the prism is reflected by face 14c inside the prism and passes out of the prism face through 14b and a contact pad 15 between the face and glass 10 into the glass window at an angle, which causes total internal reflection in the glass window. The contact pad is positioned between face 14b of the prism and the glass window to ensure that substantially all the light passes into the interior of the glass window. The contact pad is constructed from an optically clear gel type material that has a refractive index sufficiently high as to avoid any reflection at the surface. A suitable material would be an optically clear pad of soft silicon.

Once the light has entered the interior of the glass window it is reflected internally several times between the parallel faces 16, 17 of the window as indicated at 18 until it reaches a second contact pad 19, which is similar to the contact pad 15, where because of the refractive index of the pad, the light escapes from the glass window into a further prism 20 through face 20b of the prism. The light is reflected inside the prism by face 20c which lies at right angles to the window before escaping through the hypotenuse face 20a. The light is directed how the prism into a lens 21 which concentrates the beam onto light sensors 22.

The wavelength of the light emitted by the source 12 is matched to the sensitivity of the sensors 22 to minimise the effects of stray light.

At the start of the sterilisation cycle the inside surface of the glass window is clean and all of the light is reflected inside the glass window and is directed onto the light sensors. As the inside surface of the glass window is subjected to saturated vapour droplets of dew will form on the surface. At the point of formation of dew on the surface there will be a change in the refractive index and light will escape through the droplet thus reducing the amount of light energy arriving at the light sensor. As the process of formation or evaporation of droplets occurs there will be a change in the amount of light energy that escapes and hence the amount of light energy arriving at the light sensor.

An amplifier circuit with both zero and full-scale adjustment must be connected to the output of the light sensor. The amplifier may either have a voltage or current output depending on the requirements of the monitoring or control systems. The sensors may be calibrated by first setting the zero point, i.e. with no droplets and a clean glass window, and then setting the full scale by placing a large contact pad on the interior surface which allows all of the light to escape from the window. Intermediate calibration points can be achieved by attaching the sensor to various glass windows, which have different areas that have been etched. The etching disrupts the internal reflections and hence changes the amount of light arriving at the light sensor. This method has been tried with various areas of etching and calibration points at 25%, 50% and 75% of full scale have been achieved.

These sets of etched glass have thus been used to compare the calibration of a number of sensors and found to give repeatable results within about 2%.

When used in a real chamber that has to be sterilised, visible condensation as a very fine bloom appears at about 20% of full scale on the condensation meter. At this level of condensation sterilisation is achieved between 5 and 20 minutes depending on the temperature of the chamber. Reducing the temperature increases the time to achieve sterilisation because the ‘D’ value or time to reduce the viable count by a factor of 10, is temperature dependent. It has been reported by Swatling et al (Reference III before) that reducing the temperature by 10° C. increases the ‘D’ value by a factor of 2.

One of the most critical parameters in measuring the condensation is the temperature of the glass window. If the glass window is part of the wall of the chamber this condition will be satisfied providing no local heating or cooling is applied to the area of the glass.

To overcome the difficulty of mounting the glass window into the wall of the chamber and ensuring that it is at the correct temperature, two alternative mounting methods are possible, these are shown in FIG. 2 and FIG. 3.

In FIG. 2 the condensation monitor as shown in FIG. 1 is mounted inside a box 23 on the glass window 10. The box 23 is then mounted on a chamber wall 24 on the inside of the chamber 11 to be sterilised and is connected to atmosphere by a suitable short pipe or conduit 25. The whole of the box 23 and short pipe 25 are constructed to be airtight and free from leaks. A small axial fan 26 is placed in a tube inside the short pipe to draw air out of the box. The act of drawing air out of the box causes airflow of room air at room temperature into the box, thus keeping the inside surface of the box and glass window at a temperature similar to that of the rest of the enclosure.

A similar technique may be applied as shown in FIG. 3 where the box 23 is mounted on the outside of the chamber to be sterlised. The small axial fan 26 still removes the air from the box but in this arrangement the air is replaced by air from within the chamber to be blown over the inside surface of the condensation monitor glass window 10.

The difference between the arrangements shown in FIG. 2 and FIG. 3, is that in FIG. 2 the conditions inside the box replicate the conditions on the outside of the chamber, and hence the condensation monitor is mounted inside the box, whereas in FIG. 3 the arrangement is different. In FIG. 3 the arrangement the conditions inside the box replicate the conditions inside the chamber and the condensation monitor is mounted on the outside of the box.

The above embodiments are particularly suitable for measuring condensation in the enclosure of the apparatus described and illustrated in our UK Patent Application No. 9922324.6.

References

I. M. A. Marcus et al. Pharmaceutical Technology Europe Vol 8 No Feb. 2, 1999 (24-32)

II. Watling et al. The implications of the physical properties of mixtures of hydrogen peroxide and water on the sterilisation process. ISPE conference Zurich Sept 1998

Ill. Swartling et al. The sterilizing effect against bacillus subtilis spores of hydrogen peroxide at different temperatures and concentrations. J Dairy Red (1968), 35, 423

1. A chamber having a window (10) and a condensation monitor for measuring condensation on one side of the window from the other side thereof, the monitor comprising a pair of optical devices (14, 24) positioned on said other side of the window at spaced apart locations to provide transmission of an obliquely angled beam of light into the window and transmission of an obliquely angled beam of light out of the window, a light source (12, 13) adjacent one of the devices to provide a parallel beam of light to be transmitted by said device into the window to travel along the window by reflection from side to side to the other device from where the light beam emerges, and a light sensor (21, 22) to measure the amount of light emerging from the window, the amount of light transmitted along the portion between the optical devices being dependent on the amount of condensation on said one side of the window, condensation facilitating transmission of the light beam through said one side by refraction to reduce the amount of light transmitted along the window to the light sensor, characterised in that an enclosure (23) is mounted on a wall of the chamber (11), said window (10) being formed as part of the enclosure and said one side of the window on which condensation may form being exposed to the chamber interior and the other side having said condensation monitor.

2. A chamber as claimed in claim 1, characterised in that the enclosure (23) is located within the chamber (11) with an aperture in the chamber wall communicating the interior of the enclosure with the atmosphere outside of the chamber said one side of the window (10) in the enclosure. being outside of the enclosure and exposed to the interior of the chamber and the monitor being mounted on the other side of the window within the enclosure .

3. A chamber as claimed in claim 2, characterised in that a fan (26) means is provided for causing an air flow over the condensation monitor within the enclosure.

4. A chamber as claimed in claim 3, characterised in that the enclosure (23) has an opening (24) communicating with atmosphere outside the chamber and the fan means (26) is arranged to draw air flow from outside of the enclosure through the enclosure and thence back to atmosphere outside the chamber.

5. A chamber as claimed in claim 1, characterised in that the enclosure (23) is located on the outside of the chamber (11) with an aperture in the wall of the chamber communicating the interior of the enclosure with the interior of the chamber said one side of the window (10) in the enclosure being on the inner side of the enclosure and in communication with the interior of the chamber through the aperture and the monitor being mounted on said other side of the window externally of, the enclosure.

6. A chamber as claim 5, wherein fan means (26) are provided for drawing an airflow from the chamber (11) into the enclosure (23) over said one side of the window and thence back to the chamber to enable condensation in the air contained in the chamber to be monitored.

7. A chamber as claimed in any of the preceding claims, characterised in that the optical devices comprise prisms (14, 20) mounted on said other side of the window to transmit light into and receive light from the window respectively.

8. A chamber as claimed in claim 7, characterised in that the prisms (14, 20) are adhered by light transmitting contact pads to said other side of the window (10).

9. A chamber as claimed in any of the preceding claims, characterised in that the light source (12) has a lens (13) for producing, a parallel beam of light from the source.

10. A chamber as claimed in any of the preceding claims, characterised in that the light sensor (22) has a lens (21) for focusing the parallel beam of light from the window to a point on the light sensor.
